(19) United States
(12) Patent Application Publication
(10) Pub. No.: US 2022/0289608 A1
(43) Pub. Date: Sep. 15, 2022

(54) Method for Treating FRAC and Produced Water

(71) Applicants: Jeffrey POCISK, Port Clinton, OH (US); Veolia Water Solutions & Technologies Support, Saint-Maurice (FR)

(72) Inventor: Jeffrey M. Pocisk, Port Clinton, OH (US)

(21) Appl. No.: 17/639,369

(22) PCT Filed: Aug. 21, 2020
(86) PCT No.: PCT/US2020/047316

§ 371 Date: Mar. 1, 2022

Related U.S. Application Data
(60) Provisional application No. 62/896,041, filed on Sep. 5, 2019.

(51) Int. Cl. C02F 9/00; C02F 1/00; C02F 1/52; C02F 1/58; C02F 1/04; C02F 1/66; C02F 1/68

(52) U.S. Cl. CPC C02F 9/00; C02F 1/004; C02F 1/5236; C02F 1/58; C02F 1/04; C02F 1/66; C02F 1/68; C02F 2101/101

(57) ABSTRACT

The present invention relates to a method of treating frac water containing barium, magnesium, scale-inhibiting compounds and suspending solids and reducing the effectiveness of the scale-inhibiting compounds that tend to prevent barium and magnesium from precipitating.

### FIELD OF THE INVENTION

The present invention relates to systems and processes for treating FRAC and produced water, and more particularly to a method of nullifying the effectiveness of scale-inhibiting compounds typically found in FRAC and produced water.

### BACKGROUND OF THE INVENTION

In treating FRAC and produced water, it is often essential to remove certain metals and/or salts by precipitation. For example, some metals and salts have to be removed from the FRAC or produced water prior to evaporation to prevent costly scaling in the evaporator. Oil field generated waters, however, typically contain compounds that prevent or substantially prevent the precipitation of these metals and/or salts. These compounds are typically referred to as scale inhibitors. Scale inhibitors typically target sulfate salt scales, such as barium sulfate, strontium sulfate, and calcium sulfate, increasing the solubility of these species in the FRAC water. It is desirable to remove these sulfate salts from the FRAC water upstream of evaporation equipment, as they can foul or scale evaporator heat transfer surfaces. Oil field produced waters, such as FRAC waters, are generated in multiple well sites and can have varying concentrations of scale inhibitor agents present. This can result in operational variances that affect the removal of the sulfate salts and cause problems in the downstream unit operations, specifically the scaling of thermal equipment, which results in excessive down time, less efficient operation and time-consuming cleaning procedures.

Therefore, there is a need in treating oil field waters to deactivate or at least reduce the effectiveness of scale-inhibiting compounds in the oil field waters before the waters reach certain process equipment, such as evaporators.

### SUMMARY OF THE INVENTION

The present invention relates to a process for treating FRAC or produced water containing scale-inhibiting compounds. As used herein, the term “FRAC water” includes produced water and other oil field generated waters. In many cases, FRAC water contains contaminants, such as barium sulfate and calcium and magnesium species that tend to scale process equipment, such as evaporators. Scale-inhibiting compounds that happen to be present in the water are not sufficiently effective to prevent the scaling of process equipment. However, their presence does make it difficult to remove by precipitation substantial amounts of scaling compounds, such as barium sulfate and calcium and magnesium species. The present invention, in one embodiment, deals with the scale-inhibiting compounds by mixing sulfuric acid with the FRAC water at a point upstream of process equipment that is prone to scaling. FRAC water including the sulfuric acid is adjusted to or maintained at a pH of about 2. Sulfuric acid under these pH conditions tends to deactivate the scale-inhibiting compounds. Once the scale-inhibiting compounds are deactivated or their effectiveness substantially reduced, then the scaling contaminants contained in the FRAC water can be removed via precipitation since the scale-inhibiting compounds, which tend to maintain these contaminants soluble in the FRAC water, are no longer present.

### DESCRIPTION OF THE DRAWINGS

FIG. 1 is a schematic illustration of a process according to the present invention for treating FRAC water.

### DESCRIPTION OF EXEMPLARY EMBODIMENT

FRAC water typically contains barium, strontium, sulfate, magnesium, calcium and a host of other metals and salts, as well as scale-inhibiting compositions. Systems designed to treat FRAC water often include thermal treatment units, such as evaporators. Some of the metals and salts found in the FRAC water have a tendency to scale evaporators. This problem is exacerbated due to the presence of the scale-inhibiting compositions found in the FRAC water which tend to maintain the scalings contaminants soluble and prevent their precipitation. Scale-inhibiting compositions, such as chelants, are specialized molecules designed to bind to positively charged metal ions, such as barium, calcium and magnesium, in a solution and thereby prevent these ions from forming insoluble precipitants with other ions that may be present. The process described herein aims to impair or substantially deactivate the scale-inhibiting compositions such that they do not prevent the precipitation of scaling species. Expressed in another way, the sulfuric acid aims for de-emulsification and the destruction of the scale-inhibiting compounds.

As described below, in one embodiment of the present invention, the FRAC water is treated by mixing sulfuric acid with the FRAC water upstream of an evaporator 24 and controlling the pH of the FRAC water containing the sulfuric acid at about 2 to about 3. Through testing, it has been observed that the sulfuric acid and pH control impairs and substantially reduces the effectiveness of these scale-inhibiting compositions. Once the scale-inhibiting compositions have been deactivated with the sulfuric acid, then scale forming species such as barium sulfate, strontium sulfate and hardness can be precipitated and removed via a solids-liquid separation process.

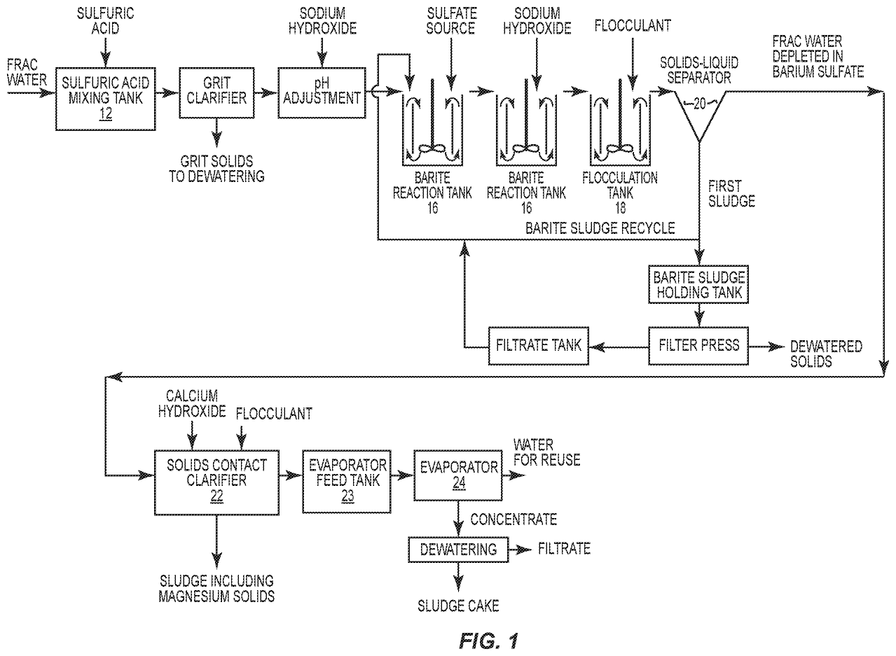

With further reference to the drawings, FIG. 1 depicts an exemplary process for treating FRAC water that includes impairing the effectiveness of scale-inhibiting compounds. FRAC water containing, for example barium, sulfate, magnesium, along with scale-inhibiting compounds, is subjected to the treatment shown in FIG. 1. People skilled in the art appreciate that the FRAC water may contain many other contaminants, some of which may be prone to scale process equipment.

FRAC water is directed into a sulfuric acid mixing tank 12. Sulfuric acid is injected into the mixing tank 12 and mixed with the FRAC water. Sufficient sulfuric acid is added to yield a pH of approximately 2-3. In a preferred embodiment, the pH of the FRAC water containing the sulfuric acid is adjusted to approximately 2 to approximately 3 and maintained in that range. As noted above, the purpose of adding the sulfuric acid is to impair the effectiveness of scale-inhibiting compositions that are typically found in FRAC water. It is postulated that the activity of scale inhibitors of the type typically found in oil well operations may be consumed with dissolved components that preferentially occupy the active sites that the scale inhibitors utilize to increase the solubility of salts such as sulfate salts. It is postulated that hydrogen ions will be effective in preferentially assuming the active sites of the scale inhibitors. Other ions, such as trivalent iron, may also preferentially consume the active sites of scale inhibitors. Testing has shown that the hydrogen ions from sulfuric acid reduce or eliminate the ability of scale inhibitor agents to affect the solubility of salts, particularly sulfate salts. The protonation of scale inhibitors is a function of the pH of the FRAC water. This means that controlling the pH of the FRAC water at an appropriate level will consistently reduce the activity of scale inhibitor agents regardless of the scale inhibitor concentration in the FRAC water feed. This consistency will permit the system and process to operate stably and reliably.

In the embodiment shown in FIG. 1, sulfuric acid is added upstream of the barite reaction tanks 16. However, in one embodiment, the sulfuric acid might be added directly into one or more of the barite reaction tanks or at a point just upstream of the barite reaction tanks. As noted above, a sulfate source is added to facilitate the precipitation of barium sulfate. When sulfuric acid is added, that may reduce the amount of the sulfate source required to bring about complete or almost complete precipitation of barium sulfate.

After mixing sulfuric acid with the FRAC water, the FRAC water is directed to a grit clarifier 14. Grit clarifier 14 removes suspended solids and free oil from the FRAC water. Prior to the FRAC water reaching the grit clarifier 14, a coagulant and a flocculant can be mixed with the FRAC water. Furthermore, an oxidant and a de-emulsifier can be mixed with the FRAC water via static mixers. A portion of the suspended solids in the FRAC water is settled in the grit clarifier 14. These settled suspended solids can be directed to a sludge holding tank and ultimately to a dewatering device such as a belt press, or the suspended solids can be sent directly to a dewatering device. An oil skimmer can be incorporated into the grit clarifier 14. An oil skimmer skims oil from the surface of the FRAC water in the grit clarifier 14 and the skimmed oil can be pumped to an oil collection tank. It should be noted that lowering the pH of the FRAC water prior to the grit clarifier facilitates the removal of organics. The lower pH aids in demulsifying the organics and also aids in the skim-off separation that takes place in the grit clarifier.

As shown in FIG. 1, downstream of the grit clarifier 14 there is another provision for pH adjustment. An alkaline reagent, such as sodium hydroxide, is mixed with the FRAC water and is effective to raise the pH to about 5.

After pH adjustment, the FRAC water is directed to one or more barite reaction tanks 16. In the example shown in FIG. 1, there are two barite reaction tanks, but it is understood by those skilled in the art that the number of barite reaction tanks can vary. A sulfate source, such as sodium sulfate, is injected into the first barite reaction tank and mixed with the FRAC water therein. In this example, in the second barite reaction tank, an alkaline reagent, such as sodium hydroxide, is injected therein and mixed with the FRAC water to raise the pH to approximately 7. The addition of a sulfate source, along with a pH adjustment, facilitates the precipitation of barium sulfate (barite). In addition, if strontium is present in the FRAC water, a portion of the strontium can also be precipitated in the barite reaction tanks as strontium sulfate. In some cases the FRAC water includes radium and naturally occurring radioactive material (NORM). There can be some precipitation of radium and other NORM in the barite reaction tanks 16. In one example, the purpose of the barite reaction tanks is to remove barium to a very low level which is generally targeted at less than 10 mg/L.

As seen in FIG. 1, downstream of the barite reaction tank 16 is a flocculation tank 18. A flocculant is mixed with the FRAC water to facilitate the precipitation of barite sulfate. Downstream of the flocculation tank 18 is a solids-liquid separator 20. This is sometimes referred to as barite clarifier. The function of the solids-liquid separator 20 is to separate the precipitated solids, particularly barium sulfate, from the FRAC water and produce an effluent that is depleted in barium sulfate. Separated solids produced by the solids-liquid separator 20 can be recycled to the first barite reaction tank 16. Furthermore, a portion of the barite sludge from the solids-liquid separator 20 can be directed to a barite sludge holding tank and from there to a filter press that produces a filtrate which can be recycled, as well as dewatered solids.

After the barium sulfate and other sulfate salts have been removed from the FRAC water, the FRAC water is directed to a solids contact clarifier 22. The purpose of the solids contact clarifier 22 is to remove selected ions and more particularly to reduce the concentration of magnesium, iron, total suspended solids and any remaining free oil in the FRAC water before the FRAC water is subjected to evaporation. As noted in FIG. 1, at this point the pH of the FRAC water is again raised. More particularly, an alkaline reagent, such as calcium hydroxide, is mixed with the FRAC water in the solids contact clarifier 22 to yield a pH of about 10. Also in some embodiments, prior to the solids contact clarifier 22, a pH adjustment tank is provided where an alkaline reagent, such as calcium hydroxide, is added to raise the pH to approximately 10 to approximately 11. Note also that to facilitate precipitation and the separation of precipitated solids, a flocculant is added in the solids contact clarifier 22. In one embodiment, the solids contact clarifier 22 provides coagulation, chemical precipitation, flotation and clarification with sludge recirculation in a single vessel. A coagulant/flocculant, such as ferric chloride, can be added and mixed with the FRAC water. Also, hydrated lime can be added to provide hydroxide alkalinity to assist in the precipitation of magnesium as magnesium hydroxide. As noted above, this can increase the pH in one embodiment to approximately 10 in order to sufficiently reduce the magnesium concentration in the FRAC water. In some embodiments, recycled sludge is added to the solids contact clarifier 22 to provide a seed crystal for the fresh precipitants. In this particular example, one may expect the total suspended solids found in the process to mainly consist of magnesium hydroxide with smaller amounts of calcium carbonate and ferric hydroxide precipitants, as well as a small concentration of oil that will adsorb onto the precipitated solids. Excess solids are removed from the solids contact clarifier 22 and can be pumped to a sludge holding tank.

Clarified FRAC water from the solids contact clarifier 22 will overflow and is directed to an evaporator feed tank 23. A pump associated with the evaporator feed tank 23 pumps the FRAC water to an evaporator 24. The evaporator produces a concentrate which is typically subjected to dewatering which in turn produces a filtrate and a sludge cake. In addition, the evaporator produces steam which condenses to form water that can be used for a variety of purposes or can be discharged.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-9. (canceled)

10. A method of treating FRAC water containing barium, magnesium, scale-inhibiting compounds and suspended solids and reducing the effectiveness of the scale-inhibiting compounds that tend to prevent barium and magnesium from precipitating from the FRAC water, the method comprising:
directing the FRAC water to a sulfuric acid mixing tank;
reducing the effectiveness of the scale-inhibiting compounds in the FRAC water by injecting sulfuric acid into the sulfuric acid mixing tank and mixing the sulfuric acid with the FRAC water which reduces the pH of the FRAC water;
after mixing the sulfuric acid with the FRAC water, mixing a first alkaline reagent with the FRAC water and raising the pH of the FRAC water;
after raising the pH of the FRAC water, directing the FRAC water to one or more barite reaction tanks located downstream from the sulfuric acid mixing tank;
mixing a second alkaline reagent with the FRAC water in the one or more barite reaction tanks and further raising the pH of the FRAC water therein;
mixing a sulfate source with the FRAC water in the one or more reaction tanks;
precipitating barium sulfate in the one or more barite reaction tanks;
directing the FRAC water and the precipitated barium sulfate to a flocculation tank located downstream of the one or more barite reaction tanks;
mixing a flocculant with the FRAC water and precipitated barium sulfate in the flocculation tank;
directing the FRAC water and the precipitated barium sulfate from the flocculation tank to a solids-liquid separator and separating a barite sludge from the FRAC water and also producing FRAC water depleted in barium sulfate; and
recycling at least a portion of the barite sludge to the one or more barite reaction tanks and mixing the barite sludge with the FRAC water.

11. The method of claim 10 further including directing at least a portion of the barite sludge to a filter press and producing dewatered sludge and a filtrate; and recycling the filtrate to the one or more barite reaction tanks.

12. The method of claim 10 further including:
directing the FRAC water, depleted in barium sulfate, to a solids contact clarifier and mixing a third alkaline reagent with the FRAC water, depleted in barium sulfate, and raising the pH of the FRAC water, depleted in barium sulfate, to about 10 or higher;
precipitating the magnesium in the solids contact clarifier and producing a magnesium sludge in the solids contact clarifier and discharging the magnesium sludge from the solids contact clarifier;
from the solids contact clarifier, directing the FRAC water, depleted in barium sulfate, to an evaporator; and
evaporating the FRAC water, depleted in barium sulfate, to produce a concentrate and steam which condenses to form water for reuse.

13. The method of claim 10 wherein mixing the sulfuric acid with the FRAC water gives rise to the presence of hydrogen ions in the FRAC water and wherein the hydrogen ions preferentially assume active sites on the scale-inhibiting compounds.

14. The method of claim 10 wherein mixing the sulfuric acid with the FRAC water de-emulsifies the FRAC water and destroys the scale-inhibiting compounds.

15. The method of claim 10 wherein, after mixing the sulfuric acid with the FRAC water, directing the FRAC water to a grit clarifier and removing suspended solids and free oil from the FRAC water in the grit clarifier prior to mixing the first alkaline reagent with the FRAC water.

16. The method of claim 15 including settling the suspended solids in the grit clarifier.

17. The method of claim 16 wherein an oil skimmer is incorporated into the grit clarifier and the method includes skimming the free oil from the FRAC water in the grit clarifier.

18. The method of claim 10 wherein there is provided two barite reaction tanks in series and wherein the sulfate source is added to a first barite reaction tank and sodium hydroxide is added in the second barite reaction tank.

19. The method of claim 10 wherein the FRAC water also includes strontium and the method includes precipitating strontium in the form of strontium sulfate in the one or more barite reaction tanks.

20. The method of claim 10 wherein the third alkaline reagent is calcium hydroxide and calcium hydroxide is mixed with the FRAC water in the solids contact clarifier.

21. A method of treating FRAC water containing barium, magnesium, scale-inhibiting compounds and suspended solids and reducing the effectiveness of the scale-inhibiting compounds that tend to prevent barium and magnesium from precipitating, the method comprising:
directing the FRAC water to a sulfuric acid mixing tank;
reducing the effectiveness of the scale-inhibiting compounds in the FRAC water by injecting sulfuric acid into the sulfuric acid mixing tank and mixing the sulfuric acid with the FRAC water;
mixing an amount of sulfuric acid with the FRAC water sufficient to yield a pH of the FRAC water of about 2 to about 3;
after mixing the sulfuric acid with the FRAC water, directing the FRAC water to a grit clarifier;
removing suspended solids and free oil from the FRAC water in the grit clarifier;
downstream of the grit clarifier, mixing a first alkaline reagent with the FRAC water and raising the pH of the FRAC water to about 5;
after raising the pH of the FRAC water to about 5, directing the FRAC water to one or more barite reaction tanks located downstream of the grit clarifier;
mixing a second alkaline reagent with the FRAC water in the one or more barite reaction tanks and raising the pH of the FRAC water therein to about 7;
mixing a sulfate source with the FRAC water in the one or more barite reaction tanks;
precipitating barium sulfate in the one or more barite reaction tanks;
directing the FRAC water and precipitated barium sulfate to a flocculation tank located downstream of the one or more barite reaction tanks;
mixing a flocculant with the FRAC water and precipitated barium sulfate in the flocculation tank;
directing the FRAC water from the flocculation tank to a solids-liquid separator and separating a barite sludge from the FRAC water and also producing FRAC water depleted in barium sulfate;
recycling a first portion of the barite sludge to the one or more barite reaction tanks and mixing the barite sludge with the FRAC water;
directing a second portion of the barite sludge to a filter press and producing dewatered sludge and a filtrate;
recycling the filtrate to the one or more barite reaction tanks;
directing the FRAC water depleted in barium sulfate to a solids contact clarifier and mixing a third alkaline reagent with the FRAC water depleted in barium sulfate and raising the pH of the FRAC water depleted in barium sulfate to about 10;
precipitating the magnesium in the solids contact clarifier and producing a magnesium sludge in the solids contact clarifier and discharging the magnesium sludge from the solids contact clarifier;
from the solids contact clarifier, directing the FRAC water depleted in barium sulfate to an evaporator; and
evaporating the FRAC water depleted in barium sulfate to produce a concentrate and steam which condenses to form water for reuse.

22. The method of claim 21 wherein mixing the sulfuric acid with the FRAC water gives rise to the presence of hydrogen ions in the FRAC water and wherein the hydrogen ions preferentially assume active sites on the scale-inhibiting compounds.

23. The method of claim 21 wherein mixing the sulfuric acid with the FRAC water de-emulsifies the FRAC water and destroys the scale-inhibiting compounds.

24. The method of claim 21 wherein prior to the FRAC water reaching the grit clarifier, a coagulant and a flocculant are mixed with the FRAC water.

25. The method of claim 21 including settling the suspended solids in the grit clarifier.

26. The method of claim 21 wherein an oil skimmer is incorporated into the grit clarifier and the method includes skimming the free oil from the FRAC water in the grit clarifier.

27. The method of claim 21 wherein there is provided two barite reaction tanks in series and wherein the sulfate source is added to a first barite reaction tank and sodium hydroxide is added in the second barite reaction tank.

28. The method of claim 21 wherein the FRAC water also includes strontium and the method includes precipitating strontium in the form of strontium sulfate in the one or more barite reaction tanks.

29. The method of claim 21 wherein the third alkaline reagent is calcium hydroxide and calcium hydroxide is mixed with the FRAC water in the solids contact clarifier.
